(19) United States
(12) Patent Application Publication
(10) Pub. No.: US 2006/0069006 A1
(43) Pub. Date: Mar. 30, 2006

(54) Polyethylene glycol and alcohol ethoxylates and their preparation

(75) Inventors: Torsten Henning, Schwerin (DE); Rainer Wagner, Burgkirchen (DE); Reinhard Vybiral, Burgkirchen (DE); Peter Berchtold, Burgkirchen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/234,721

(22) Filed: Sep. 23, 2005

(30) Foreign Application Priority Data
Sep. 24, 2004 (DE) 102004046355.7
Dec. 9, 2004 (DE) 102004059222.5-44

(51) Int. Cl. C11D 17/08

(52) U.S. Cl. 510/421

(57) ABSTRACT

Polyethylene glycols and alcohol ethoxylates having a low ethylene oxide content not exceeding 0.2 ppm and a process for preparing such substances are described.

The invention relates to novel polyethylene glycols and alcohol ethoxylates having a particularly low ethylene oxide content and to a process for the preparation thereof.

Polyethylene glycols of the formula H(OCH₂CH₂)ₙOH with n equal to 4 to 900 corresponding to average molar masses of from 180 to 40 000 g/mol, which are generally prepared by polymerizing ethylene oxide with water or polyhydric alcohols, are employed in a large number of areas of application because of their interesting properties. A large number of these applications involve the polyethylene glycol making superficial contact with the skin of living creatures, especially humans, or being administered orally or parenterally to humans or animals. Examples of such applications are solvents for active ingredients, flavorings or fragrances in medicinal drops, solutions for injection, dietary supplements, tablets, ointments, sticks, suppositories or gelatin capsules; plasticizers for coatings of film-coated tablets; binders in tablets; humectants in toothpastes; moisturizers and/or conditioners in shower preparations, shampoos, cream rinses, hair treatments, soaps, liquid soaps, hair sprays, hair gels, after-shave products, face packs, sunscreen products, creams or lotions; ingredient of multiphase products such as two-phase shower preparations, two-phase foam baths or three-phase bath oils; and active ingredient in eye drops, laxatives or solutions having antiapoptotic activity.

Products with similar areas of application are generally obtained by polymerizing ethylene oxide with alcohols.

It is important for these applications that the content of substances harmful for the living organism, such as, for example, the residual monomer content, is kept as low as possible. In the present case of polyethylene glycols or alcohol ethoxylates, the monomer used is ethylene oxide. It is also desired to keep the content of byproducts as low as possible. In the case of the preparation of polyethylene glycols and alcohol ethoxylates by use of ethylene oxide, an example of a harmful byproduct is 1,4-dioxane.

The requirement for use in pharmaceutical products in the monograph 07/2003:1444 “Macrogols” in the European Pharmacopoeia (Ph. Eur.) 4.5 (valid since July 2003) and in the monograph “Polyethylene glycols” in the United States Pharmacopoeia/National Formulary (USP/NF) 16/28 therefore is a maximum residual ethylene oxide content, determined by gas chromatography, not exceeding 1 ppm. The requirement for dioxane in the abovementioned monographs is a maximum limit of 10 ppm.

Commercially available polyethylene glycol and commercially available alcohol ethoxylates also in fact show this low residual ethylene oxide content with levels of about 0.8 to 1.0 ppm, and the required low residual dioxane content with levels of about 1 to 10 ppm.

However, in the food industry, according to the EU Commission Directive 2003/95/EC of Oct. 27, 2003, the requirement as purity criterion for food additives is now, in response to the Scientific Committee on Food Opinion of May 6, 2002, a stricter limit of not more than 0.2 ppm residual ethylene oxide in ethoxylated substances, including polyethylene glycols, specifically polyethylene glycol 6000. Such polyethylene glycol and corresponding alcohol ethoxylates have, however, not appeared on the market to date. Moreover, no process for preparing polyethylene glycols and alcohol ethoxylates having this low residual content of ethylene oxide not exceeding 0.2 ppm is known as yet.

It was therefore an object of the invention to provide polyethylene glycols of the formula H(OCH₂CH₂)ₙOH with n equal to 4 to 900 corresponding to average molar masses of from 180 to 40 000 g/mol having the abovementioned low residual content of ethylene oxide of not more than 0.2 ppm.

It was a further object of the invention to provide corresponding alcohol ethoxylates which likewise have the abovementioned low residual content of ethylene oxide not exceeding 0.2 ppm.

It has now surprisingly been found that these objects are achieved when a glycol or a monoalcohol is ethoxylated in the presence of a catalyst with ethylene oxide, and the resulting reaction mixture is subsequently treated with steam and, where appropriate, dried or subjected to a water washing and drying.

The invention accordingly relates to a polyethylene glycol or an alcohol ethoxylate of the formula (I)
R(OCH₂CH₂)ₙOH (I)
in which
R is H, a linear or branched alkyl radical having 1 to 30 carbon atoms, a linear or branched alkenyl radical having 2 to 30 carbon atoms or an aryl radical which may also be substituted by 1 to 3 linear or branched alkyl groups having in each case 1 to 12 carbon atoms, and
n is 4 to 900 corresponding to average molar masses of the (OCH₂CH₂)ₙOH groups of from 180 to 40 000 g/mol,
wherein the polymers of the formula (I) have an ethylene oxide content not exceeding 0.2 ppm.

In a preferred embodiment of the invention, R is H.

In a further preferred embodiment of the invention, R is not H.

Where R is an alkyl group, it preferably has 1 to 22 and particularly preferably 1 to 18 carbon atoms.

Where R is an alkenyl group, it preferably has 6 to 22 and particularly preferably 8 to 18 carbon atoms.

The optionally substituted aryl radical is preferably a phenyl radical or a substituted phenyl radical.

The alkyl groups of the substituted aryl radicals preferably have from 3 to 10 carbon atoms and are particularly selected from butyl and nonyl groups.

Where R is not H, this radical is preferably selected from alkyl radicals.

It is preferred for n in the inventive polyethylene glycol or alcohol ethoxylate of the formula (I) to be 32 to 800 corresponding to an average molar mass of the (OCH₂CH₂)ₙOH groups of from 1500 to 35 000 g/mol.

The ethylene oxide content in the inventive polyethylene glycol or alcohol ethoxylate of the formula (I) preferably does not exceed 0.1 ppm.

The invention further relates to a process for preparing the polymers of the formula (I).

The inventive process for preparing the polyethylene glycol or alcohol ethoxylate of the formula (I) comprises a glycol or an alcohol of the formula (II)
R^{a}OH (II)
in which
R^{a} is a linear or branched alkyl radical having 1 to 30 carbon atoms, a linear or branched alkenyl radical having 2 to 30 carbon atoms, it also being possible for the alkyl or alkenyl radicals to be ethoxylated, in which case they comprise 1 to 30 —CH₂CH₂O— groups, or an aryl radical which may also be substituted by 1 to 3 linear or branched alkyl groups having in each case 1 to 12 carbon atoms,
being
ethoxylated in the presence of a catalyst with ethylene oxide, and the resulting reaction mixture subsequently being either treated with steam and optionally dried or subjected to a water washing and drying.

Unlike the radical R in formula (I), R^{a} in formula (II) cannot be H. Otherwise, the preferred R^{a} radicals correspond to the above-mentioned preferred R radicals. In addition, R^{a} may also be an ethoxylated alkyl or alkenyl radical. In this case, these radicals preferably comprise 1 to 10 and particularly preferably 1 to 3 —CH₂CH₂O— groups.

The drying preferably takes place by the water which has been introduced inter alia through the steam treatment or the water washing into the reaction mixture being removed by distillation. This distillation may, where appropriate, take place under a pressure which is reduced from atmospheric pressure.

It is advantageously possible with the inventive process also to achieve a low dioxane content in the product. The dioxane content in the inventive polyethylene glycol or alcohol ethoxylate of the formula (I) preferably does not exceed 1 ppm, particularly preferably does not exceed 0.5 ppm and especially preferably does not exceed 0.1 ppm.

The preparation of polyethylene glycol or alcohol ethoxylate by ethoxylation of glycols or monoalcohols is known to the skilled worker and can be carried out for example as described in “1,2-Epoxide Polymers, Preparation” in: Encyclopedia of polymer science and engineering, John Wiley & Sons, Inc., revised edition 1986, page 242 et seq.

Previously disclosed processes for preparing polyethylene glycol or alcohol ethoxylate by ethoxylation of glycols or monoalcohols which are, however, carried out without the step of subsequent treatment with steam and optionally subsequent drying or without the step of water washing with subsequent drying, are unsuitable for achieving the low content of ethylene oxide not exceeding 0.2 ppm. In particular, they are unsuitable for achieving a low content of ethylene oxide not exceeding 0.2 ppm and at the same time a low dioxane content not exceeding 1 ppm.

It is proposed for example in EP 1 245 608 A1 to reduce the ethylene oxide content from the polyethylene glycol reaction product by reducing the content of unreacted residual ethylene oxide by applying a vacuum. However, it is possible by such a procedure to reduce the ethylene oxide from the viscous polyglycol mixture only down to a level of about 0.8 to 1.0 ppm, but not to the desired maximum limit of 0.2 ppm.

In a further preferred embodiment, the inventive process is carried out in such a way that the precursor is a glycol and is selected from the group consisting of monoethylene glycol and higher ethylene glycols having an average molar mass of up to 10 000 g/mol. The glycol is particularly preferably selected from mono-, di- or triethylene glycol.

In a particularly preferred embodiment of the inventive process, the mono-, di- or triethylene glycol is purified by distillation before the reaction. The mono-, di- or triethylene glycol is in this case in turn preferably obtained from a glycol mixture by distillation, particularly preferably from a glycol mixture which has been prepared by the reaction of ethylene oxide with water.

In an extremely preferred embodiment of the inventive process, monoethylene glycol which has been obtained from a glycol mixture by distillation under a pressure of from 0 to 40 hPa and at a temperature of from 90 to 200° C., preferably under 5 to 20 hPa and at 100 to 150° C., particularly preferably under 10 hPa and at 120° C., is used as precursor.

In a further extremely preferred embodiment of the inventive process, diethylene glycol which has been obtained from a glycol mixture by distillation under a pressure of from 0 to 40 hPa and at a temperature of from 100 to 220° C., preferably under 5 to 20 hPa and at 110 to 180° C., particularly preferably under 10 hPa and at 120° C., is used as precursor.

In a further extremely preferred embodiment of the inventive process, triethylene glycol which has been obtained from a glycol mixture by distillation under a pressure of from 0 to 40 hPa and at a temperature of from 140 to 250° C., preferably under 5 to 10 hPa and at 140 to 160° C., particularly preferably under 5 hPa and at 140° C., is used as precursor.

In a further preferred embodiment of the inventive process, the precursor is an alcohol of the formula (II) which is selected from methanol, methyl glycol, methyl diglycol, ethanol, propanol, butanol, phenol, nonylphenol, tributylphenol, C₁₁ alcohol such as C₁₁ oxo alcohol, lauryl alcohol, oleyl alcohol, C₁₄ and C₁₅ alcohols such as C₁₄/C₁₅ oxo alcohol, cetyl alcohol, cetearyl alcohol, stearyl alcohol, isotridecyl alcohol, C₁₀ to C₁₂ alcohols such as C₁₀/C₁₂ Ziegler alcohol, C₁₂ to C₁₅ alcohol such as C₁₂/C₁₅ oxo alcohol and mixtures thereof.

In a further preferred embodiment of the inventive process, the catalyst is employed in dry form or as solution.

The catalyst used in the inventive process is preferably selected from alkali metal hydroxide or alkaline earth metal hydroxide, particularly preferably from sodium hydroxide or potassium hydroxide.

It is particularly preferred to use in the inventive process dry or distilled monoethylene glycol, diethylene glycol or triethylene glycol or alcohol of the formula (II) together with dry alkali metal hydroxide or alkaline earth metal hydroxide, preferably sodium hydroxide or potassium hydroxide.

In a further preferred embodiment of the inventive process, the mixture of glycol or alcohol of the formula (II) and catalyst or of glycol or alcohol of the formula (II) and catalyst solution is dried before the ethoxylation. The drying preferably takes place under vacuum.

In a further preferred embodiment of the inventive process, the ethoxylation is carried out under a nitrogen atmosphere at a temperature of from 100 to 160° C.

In a further preferred embodiment of the inventive process, the reaction mixture or the catalyst is neutralized with acid after the steam treatment and, where appropriate, the drying or the water washing with subsequent drying. The acid is preferably selected from lactic acid, acetic acid and isononanoic acid.

In a preferred embodiment of the inventive process, the reaction mixture is subsequently treated with steam.

In a further preferred embodiment of the inventive process, the steam treatment is followed by a drying.

In a further preferred embodiment of the inventive process, the procedure for the treatment of the reaction mixture with steam is such that the pressure in the reactor is adjusted to 5-500 mbar before the steam is passed in, preferably to 10-350 mbar, particularly preferably to 10-200 mbar and especially preferably to 50-120 mbar, and the treatment of the reaction mixture with steam is carried out at a temperature of from 100 to 180° C., preferably 110 to 150° C., for 1 to 180 minutes, preferably 10 to 90 minutes.

In a particularly preferred embodiment, the pressure in the reactor is adjusted to 10-200 mbar before the steam is passed in, and the treatment of the reaction mixture with steam is carried out at a temperature of from 100 to 180° C. for 1 to 180 minutes. Preference is in turn given to an embodiment in which the pressure in the reactor is adjusted to 50-120 mbar before the steam is passed in, and the treatment of the reaction mixture with steam is carried out at a temperature of from 110 to 150° C. for 10 to 90 minutes.

The vacuum which is initially applied is impaired by passing in the steam. The impairment of the vacuum through the passing in of steam may be for example by 50-300 mbar or by 100-200 mbar, depending on the chosen conditions.

In a further preferred embodiment of the inventive process, the procedure for the water washing is to reduce the temperature to 20 to 90° C., preferably 25 to 80° C., and then to feed in water in amounts of from 1 to 95% by weight, preferably 5 to 50% by weight, based on the reaction mixture. The water washing is preferably carried out under atmospheric pressure.

The invention further also relates to a polyethylene glycol or an alcohol ethoxylate of the formula (I) obtainable by the inventive process.

The following examples serve to explain the invention in detail without, however, restricting it thereto. All percentage data are percentages by weight.

### EXAMPLE 1a

### Preparation of Polyethylene Glycol with an Average Molar Mass of 200 g/mol

7491 kg of triethylene glycol which has been obtained by distillation under mild conditions at 140° C. under 5 hPa were mixed with 5 kg of 50% strength aqueous sodium hydroxide solution as catalyst and dried at 110° C. in vacuo for 1 hour. Then 2498 kg of gaseous ethylene oxide were introduced under a nitrogen atmosphere. After the reaction had taken place, the pressure was adjusted to 100 mbar and then steam was passed through the reaction mixture at 130° C. for 60 minutes. The reaction mixture was then neutralized with 6 kg of 90% strength lactic acid. Determination by gas chromatography showed the residual ethylene oxide content at 0.1 ppm and the residual dioxane content at 0.1 ppm.

### EXAMPLE 1b

### Preparation of Polyethylene Glycol with an Average Molar Mass of 200 g/mol

7491 kg of triethylene glycol which has been obtained by distillation under mild conditions at 140° C. under 5 hPa were mixed with 5 kg of 50% strength aqueous sodium hydroxide solution as catalyst and dried at 110° C. in vacuo for 1 hour. Then 2498 kg of gaseous ethylene oxide were introduced under a nitrogen atmosphere. After the reaction had taken place, 50% water, based on the reaction mixture, were introduced at 80° C. under atmospheric pressure. After drying by removal of the water by distillation, the reaction mixture was neutralized with 6 kg of 90% strength lactic acid.

Determination by gas chromatography showed the residual ethylene oxide content at 0.1 ppm and the residual dioxane content at 0.1 ppm.

### COMPARATIVE EXAMPLE 1

### Preparation of Polyethylene Glycol with an Average Molar Mass of 200 g/mol

7491 kg of triethylene glycol which has been obtained by distillation under mild conditions at 140° C. under 5 hPa were mixed with 5 kg of 50% strength aqueous sodium hydroxide solution as catalyst and dried at 110° C. in vacuo for 1 hour. Then 2498 kg of gaseous ethylene oxide were introduced under a nitrogen atmosphere. After the reaction had taken place, a vacuum of 100 mbar was applied at 130° C. for 60 minutes. The reaction mixture was then neutralized with 6 kg of 90% strength lactic acid.

Determination by gas chromatography showed the residual ethylene oxide content at 1.0 ppm and the residual dioxane content at 10 ppm.

### EXAMPLE 2

### Preparation of Polyethylene Glycol with an Average Molar Mass of 3000 g/mol

13 460 kg of gaseous ethylene oxide were introduced under a nitrogen atmosphere into 11 380 kg of a PEG 1500 (polyethylene glycol with an average molar mass of 1500 g/mol) which had been made alkaline with NaOH. After the reaction had taken place, the pressure was adjusted to 100 mbar and then steam was passed through the reaction mixture at 130° C. for 60 minutes. The reaction mixture was then neutralized with 6 kg of 90% strength lactic acid.

Determination by gas chromatography showed the residual ethylene oxide content at 0.1 ppm and the residual dioxane content at 0.1 ppm.

### COMPARATIVE EXAMPLE 2

### Preparation of Polyethylene Glycol with an Average Molar Mass of 3000 g/mol

126 720 kg of gaseous ethylene oxide were introduced under a nitrogen atmosphere into 11 380 kg of a PEG 1500 which had been made alkaline with NaOH. After the reaction had taken place, a vacuum of 100 mbar was applied at 130° C. for 60 minutes. The reaction mixture was then neutralized with 6 kg of 90% strength lactic acid.

Determination by gas chromatography showed the residual ethylene oxide content at 1.0 ppm and the residual dioxane content at 10 ppm.

1. A composition substance of the formula (I)
R(OCH₂CH₂)ₙOH (I)
in which
R is selected from the group consisting of H, a linear or branched alkyl radical having 1 to 30 carbon atoms, a linear or branched alkenyl radical having 2 to 30 carbon atoms, an aryl radical, and a substituted aryl radical having 1 to 3 linear or branched alkyl groups having in each case 1 to 12 carbon atoms, and mixtures thereof, and
n is 4 to 900,
wherein the ethylene oxide content does not exceed 0.2 ppm.

2. The composition as claimed in claim 1, wherein n is from 32 to 800.

3. The composition as claimed in claim 1, wherein the ethylene oxide content does not exceed 0.1 ppm.

4. The composition of claim 1 having a dioxane content not exceeding 1 ppm.

5. The composition as claimed in claim 4, wherein the dioxane content does not exceed 0.5 ppm.

6. A process for preparing the composition of claim 1, comprising ethoxylating a precursor in the presence of a catalyst with ethylene oxide, wherein the precursor is a glycol or an alcohol, or mixture thereof of the formula (II)
R^{a}OH (II)
in which
R^{a} is selected from the group consisting of a linear or branched alkyl radical having 1 to 30 carbon atoms, a linear or branched alkenyl radical having 2 to 30 carbon atoms, an ethoxylated alkyl or alkenyl radical having 1 to 30 —CH₂CH₂O— groups, an aryl radical, a substituted aryl radical having 1 to 3 linear or branched alkyl groups having in each case 1 to 12 carbon atoms, and mixtures thereof,
and subsequently treating the resulting reaction mixture with steam and optionally drying the steamed reaction mixture or washing the resulting reaction mixture with water and drying to provide said composition.

7. The process as claimed in claim 6, wherein the precursor is a glycol and is selected from the group consisting of monoethylene glycol and an ethylene glycols having an average molar mass of up to 10 000 g/mol, and mixtures thereof.

8. The process as claimed in claim 6, wherein the precursor is a glycol and is selected from the group consisting of mono-ethylene glycol, di-ethylene glycol, triethylene glycol, and mixtures thereof.

9. The process as claimed in claim 8, wherein the glycol has been purified by distillation before the ethoxylating reaction.

10. The process of claim 8, wherein the glycol has been obtained from a glycol mixture selected from the group consisting of mono-ethylene glycol, di-ethylene glycol, triethylene glycol, and mixtures thereof by distillation.

11. The process as claimed in claim 10, wherein the glycol mixture has been prepared by the reaction of ethylene oxide and water.

12. The process of claim 8, wherein the precursor is monoethylene glycol which has been obtained by distillation under a pressure of from 0 to 40 hPa and at a temperature of from 90 to 200° C.

13. The process of claim 8, wherein the precursor is diethylene glycol which has been obtained by distillation under a pressure of from 0 to 40 hPa and at a temperature of from 100 to 220° C.

14. The process of claim 8, wherein the precursor is triethylene glycol which has been obtained by distillation under a pressure of from 0 to 40 hPa and at a temperature of from 140 to 250° C.

15. The process as claimed in claim 6, wherein the precursor is an alcohol of the formula (II) which is selected from the group consisting of methanol, methyl glycol, methyl diglycol, ethanol, propanol, butanol, phenol, nonylphenol, tributylphenol, C₁₁ alcohol, lauryl alcohol, oleyl alcohol, C₁₄ and C₁₅ alcohols, cetyl alcohol, cetearyl alcohol, stearyl alcohol, isotridecyl alcohol, C₁₀ to C₁₂ alcohols, C₁₂ to C₁₅ alcohol, and mixtures thereof.

16. The process of claim 6, wherein the catalyst is employed in dry form or as a solution.

17. The process of claim 6, wherein the catalyst is alkali metal hydroxide or alkaline earth metal hydroxide or mixtures thereof.

18. The process as claimed in claim 17, wherein the catalyst is sodium hydroxide or potassium hydroxide or mixtures thereof.

19. The process of claim 6, wherein the precursor and catalyst are dried before the ethoxylating step.

20. The process of claim 6, wherein the ethoxylation is carried out under a nitrogen atmosphere at a temperature of from 100 to 160° C.

21. The process of claim 6, further comprising neutralizing the reaction mixture is with acid after the steam treatment.

22. The process as claimed in claim 21, wherein the acid is selected from the group consisting of lactic acid, acetic acid, isononanoic acid, and mixtures thereof.

23. (canceled)

24. The process of claim 6, wherein the steam treatment is followed by drying.

25. The process of claim 6, wherein prior to the steam treatment the pressure is adjusted to 5-500 mbar before the steam is introduced, and the steam treatment is carried out at a temperature of from 100 to 180° C. for 1 to 180 minutes.

26. The process as claimed in claim 6, wherein the steam treatment is carried out at a temperature of from 110 to 150° C. for 10 to 90 minutes.

27. A composition obtained by a process of claim 6.

28. The process of claim 6, further comprising neutralizing the resulting reaction mixture with acid and drying the neutralized mixture, or the neutralizing the resulting reaction mixture with acid, and water washing, and drying the neutralized mixture.
